(19) United States
(12) Patent Application Publication
(10) Pub. No.: US 2019/0184849 A1
(43) Pub. Date: Jun. 20, 2019

(54) CHARGING DEVICE FOR ELECTRIC VEHICLE

(71) Applicant: LG INNOTEK CO., LTD., Seoul (KR)

(72) Inventor: Myung Keun LIM, Seoul (KR)

(73) Assignee: LG INNOTEK CO., LTD., Seoul (KR)

(21) Appl. No.: 16/326,114

(22) PCT Filed: Aug. 16, 2017
(86) PCT No.: PCT/KR2017/008882

§ 371 Date: Feb. 15, 2019

(30) Foreign Application Priority Data
Aug. 16, 2016 (KR) 10-2016-0103821

(51) Int. Cl. B60L 53/14; B60L 53/62; H01H 47/00

(52) U.S. Cl. CPC B60L 53/14; H01H 47/002; B60L 53/62

(57) ABSTRACT

According to one embodiment of the present invention, a charging device for an electric vehicle can comprise: a relay unit arranged between an inlet and a battery so as to enable an output voltage of the inlet to be provided to the battery; a first voltage sensing unit for sensing the output voltage of the inlet; a second voltage sensing unit for sensing an output voltage of the relay; and a relay control unit for receiving output signals of the first voltage sensing unit and the second voltage sensing unit, and determining whether the sensed voltages are voltages within a normal range so as to control the ON/OFF of the relay unit.

### TECHNICAL FIELD

The present invention relates to a charging device of an electric vehicle, and more specifically, to a charging device of an electric vehicle, which can sense welding of a relay.

### BACKGROUND ART

An eco-friendly vehicle, such as an electric vehicle (EV) or a plug-in hybrid electric vehicle (PHEV), uses an electric vehicle supply equipment (EVSE) installed in a charging station to charge a battery.

To this end, a charging cable of the electric vehicle supply equipment may be connected to the inlet of the electric vehicle.

At this point, when an excessive voltage is applied by the electric vehicle supply equipment to the charging system of the electric vehicle, supply of power should be cut off to protect the electric vehicle.

Generally, a relay is used to control supply of power from a high-voltage battery pack to a motor or the like.

For example, in an electric vehicle, a hybrid vehicle or the like, a relay is installed between a battery pack and a high-voltage voltmeter circuit component to control supply of power from the high-voltage battery pack to a high-voltage voltmeter circuit component. In addition, connection and disconnection of the high-voltage voltmeter circuit component and the battery pack is performed by the relay according to the control state of the vehicle.

Here, the purpose of using the relay is to secure perfect electrical insulation between an energy storage medium and the other systems and to secure electrical safety by opening the relay in a key-off, maintenance or emergency situation although power is supplied as the relay is short-circuited while the vehicle operates. In addition, the relay is used to prevent occurrence of a serious secondary accident, such as an electrical shock, a fire or the like, generated by high voltage when a primary accident occurs and to cut off dark current of the battery pack.

Therefore, if welding occurs in the relay due to overcurrent or the like, abnormal current flows in the battery system, and a dangerous situation arises.

For example, in the case of a hybrid vehicle, a back electromotive force (EMF) voltage is generated by the back EMF of the motor according to the RPM of the engine when the motor controller is out of order, and a situation of overcharging the battery occurs. At this point, although the battery control unit opens the relay to protect the battery when overcharge occurs in the battery, if the relay is welded by any reason despite the open command of the control unit, eventually, there is a possibility of ignition and explosion of the vehicle due to continuous overcharge.

Accordingly, in a battery system for various kinds of electric vehicles (HEV, PHEV, EV, etc.) or energy storage systems (ESS), detecting whether welding occurs in the relays connected to the battery pack is important for safety.

However, in a conventional electric vehicle, although a reverse phase occurs in the voltage inputted from the inlet terminal, this cannot be sensed and may damage the charging system, and whether or not the relay is in a welded state cannot be confirmed when the relay is switched off after the electric vehicle is charged.

### DISCLOSURE OF INVENTION

### Technical Problem

An object of the present invention is to provide a charging device of an electric vehicle, which can detect welding of a relay.

Another object of the present invention is to provide a charging device, which can protect the electric system of an electric vehicle by sensing output voltage of the inlet and cutting off the relay when there is an abnormality.

### Technical Solution

To accomplish the above objects, according to one aspect of the present invention, there is provided a charging device of an electric vehicle, the device including: an inlet connected to a connector of a charging cable to receive power from an electric vehicle supply equipment and receive a control pilot signal; a relay unit arranged between the inlet and a battery so that output voltage of the inlet may be provided to the battery; a first voltage sensing unit for sensing the output voltage of the inlet; a second voltage sensing unit for sensing output voltage of the relay unit; and a relay control unit for receiving output signals of the first voltage sensing unit and the second voltage sensing unit, determining whether the sensed voltages are voltages within a normal range, and controlling on and off of the relay unit.

In addition, in the charging device of an electric vehicle according to an embodiment of the present invention, the relay control unit may control the relay unit to be switched off when the output voltage of the inlet is in a reverse phase.

In addition, in the charging device of an electric vehicle according to an embodiment of the present invention, the relay control unit may compare the output voltage of the inlet and the output voltage of the relay unit after charging the electric vehicle is completed, and determine that the relay is welded if a difference between the voltages is smaller than a set voltage difference.

In addition, in the charging device of an electric vehicle according to an embodiment of the present invention, the relay unit may include: a first relay connected to a plus terminal of the inlet; and a second relay connected to a minus terminal of the inlet, in which the relay control unit may determine that a corresponding relay is welded if any one of a voltage difference between both sides of the first relay and a voltage difference between both sides of the second relay is smaller than a set voltage difference.

In addition, in the charging device of an electric vehicle according to an embodiment of the present invention, the relay control unit may switch off the first relay and the second relay after switching on the relays when it is determined that any one of the first relay and the second relay is welded.

In addition, in the charging device of an electric vehicle according to an embodiment of the present invention, the inlet may include: port No. 1 and port No. 2 connected to contact No. 1 and contact No. 2 of the connector of the charging cable to receive AC power; port No. 3 connected to contact No. 3 and a protective earth of the connector of the charging cable; port No. 4 connected to contact No. 4 of the connector of the charging cable to receive a control pilot signal; and port No. 5 connected to contact No. 5, i.e., a proximity detection contact, of the connector of the charging cable.

In addition, in the charging device of an electric vehicle according to an embodiment of the present invention, the control pilot signal may be a pulse width modulation (PWM) signal, and when the control pilot signal is inputted into port No. 3, power may be inputted into port No. 1 and port No. 2.

### Advantageous Effects

According to an embodiment of the present invention, when there is an abnormality in the voltage inputted into an electric vehicle, the charging device of the electrical vehicle can be protected by sensing the abnormality and cutting off the relay.

In addition, according to an embodiment of the present invention, a welding state of the relay can be detected by comparing the voltages on both sides of the relay.

In addition, according to an embodiment of the present invention, shortening of the lifespan of the relay can be prevented by detecting welding of the relay and switching off the relay.

### BRIEF DESCRIPTION OF THE DRAWINGS

FIG. 1 is a block diagram showing a charging system of an electric vehicle according to an embodiment of the present invention.

FIGS. 2 to 4 are views illustrating the methods of connecting an EV and an EVSE.

FIG. 5 is a view showing an example of a charging cable for establishing a connection between an EV and an EVSE.

FIG. 6 is a view showing an example of basic interface type 1 for single-phase.

FIG. 7 is a view showing an example of basic interface type 2 for three-phase.

FIGS. 8a and 8b are views showing a connection relation between a charging cable and an EV.

FIG. 9 is a block diagram showing a charging device according to an embodiment of the present invention.

FIG. 10 is a table showing interface types applicable according to a charging mode of charging an EV.

### DESCRIPTION OF SYMBOLS

10: Electric vehicle
20: Electric vehicle supply element
50: Charging cable
60: Inlet
70: Battery
100: Charging device
110: First voltage sensing unit
120: Relay unit
130: Relay control unit
140: Second voltage sensing unit

### BEST MODE FOR CARRYING OUT THE INVENTION

As the present invention may make diverse modifications and have several embodiments, particular embodiments will be illustrated in the drawings and described in detail in the detailed description. However, this is not intended to limit the present invention to particular modes of practice, and it is to be appreciated that all changes, equivalents, and substitutes that do not depart from the spirit and technical scope of the present invention are encompassed in the present invention.

Although the terms including ordinal numbers such as first, second, etc. may be used herein to describe various elements, these elements should not be limited by these terms.

These terms are only used to distinguish one element from another. For example, a first element may be termed as a second element, and, similarly, a second element may also be termed as a first element, without departing from the scope of the present invention. As used herein, the term “and/or” includes a combination or any one of one or more of the associated listed items.

It should be understood that when a constitutional component is referred to as being “connected” or “coupled” to another element, it may be directly connected or coupled to the other element or intervening elements may be present. In contrast, when an element is referred to as being “directly connected” or “directly coupled” to another element, it should be understood that there are no intervening elements.

The terms used in this application are for the purpose of describing particular embodiments only and is not intended to limit the present invention. As used herein, the singular forms are intended to include the plural forms as well, unless the context clearly indicates otherwise. It will be further understood that the terms such as “include” and/or “have” used in this application specify the presence of stated features, integers, steps, operations, elements, and/or components, but do not preclude the presence or addition of one or more other features, integers, steps, operations, elements, components, and/or groups thereof.

Unless otherwise defined, all terms used herein, including technical or scientific terms, have the same meanings as those generally understood by those with ordinary knowledge in the field of art to which the present invention belongs. Such terms as those defined in a generally used dictionary are to be interpreted to have the meanings equal to the contextual meanings in the relevant field of art, and are not to be interpreted to have ideal or excessively formal meanings unless clearly defined in the present application.

Hereafter, embodiments will be described in detail with reference to the accompanying drawings, and the same reference numerals are assigned to the same or corresponding constitutional components regardless of symbols of the drawings, and repeated descriptions thereof will be omitted.

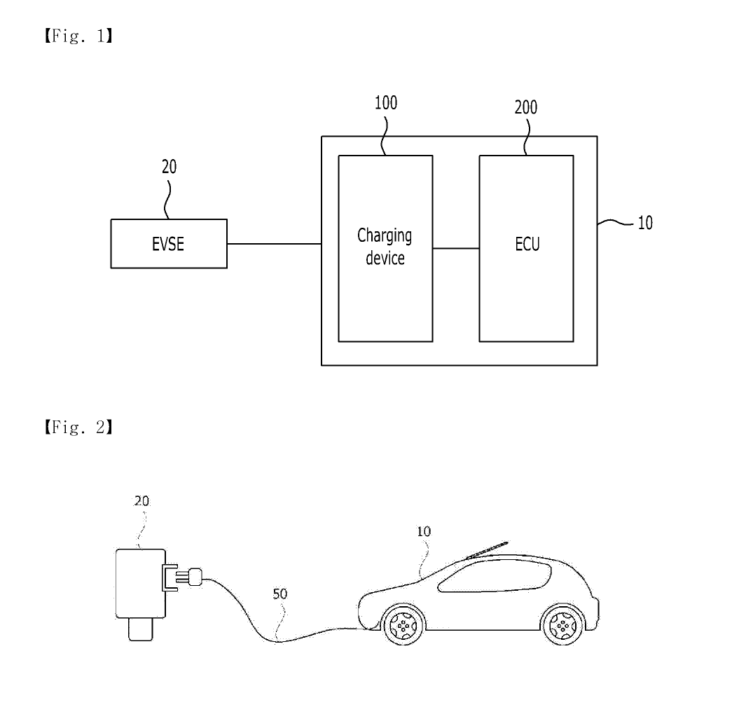

FIG. 1 is a block diagram showing a charging system of an electric vehicle according to an embodiment of the present invention.

Referring to FIG. 1, an electric vehicle (EV) 10 may be charged from an electric vehicle supply equipment (EVSE) 20.

To this end, a charging cable connected to the EVSE 20 may be connected to the inlet of the EV 10.

Here, the EVSE 20 is a facility for supplying AC or DC power, and may be arranged in a charging station or at home and implemented to be portable. In this specification, the EVSE 20 may be interchangeably used together with a charging station (supply), an AC charging station (AC supply), a DC charging station (DC supply), a socket-outlet and the like.

The charging device 100 is included in the EV 10 and connected to an electronic control unit (ECU) 200 installed in the EV 10.

The charging mode of charging the EV 10 may be classified into various categories according to the method of connecting the EVSE 20 and the EV 10. For example, the charging mode may be classified into mode 1 of connecting the EV 10 and an AC supply network using a standardized socket-outlet, mode 2 of connecting the EV 10 and the AC supply network using a system and a control pilot (CP) function for protecting an electrical shock between the EV 10 and a plug or part of an in-cable control box, mode 3 of permanently connecting the EV and the AC supply network using a dedicate EVSE in which the CP function is extended into the control device of the EVSE, and mode 4 of connecting the EV and the AC supply network using a DC EV charging station (e.g., an off-board charger) in which the CP function is extended into the DC EV charging station.

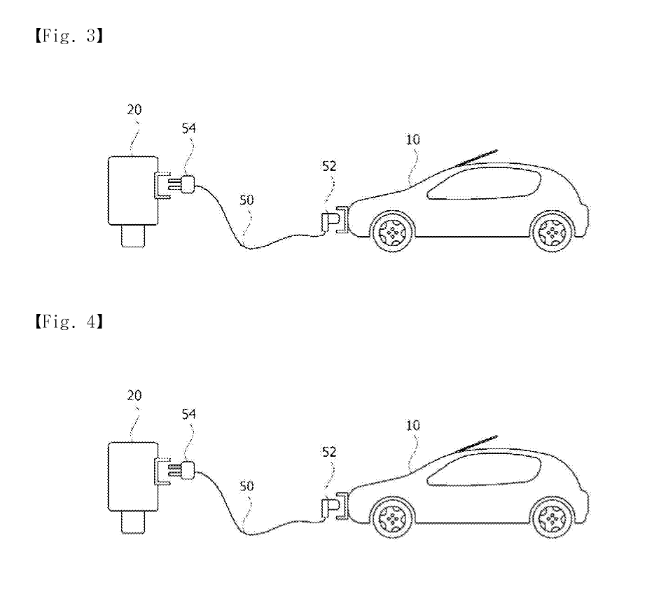

Meanwhile, the EV 10 and the EVSE 20 may be connected in a variety of methods. FIGS. 2 to 4 are views illustrating the methods of connecting the EV 10 and the EVSE 20.

Referring to FIG. 2, the EV 10 and the EVSE 20 are connected using a charging cable 50, and the plug of the charging cable 50 may be permanently installed in the EV 10. At this point, the charging cable 50 may be connected to a socket-outlet for household or industrial use or a charging station.

Referring to FIG. 3, the EV 10 and the EVSE 20 are connected using a detachable charging cable 50, and the charging cable 50 may include a connector 52 on the vehicle side and a plug 54 on the EVSE side, i.e., a connector 54 on the socket-outlet side or the charging station side and fixed to a wall.

Referring to FIG. 4, the EV 10 and the EVSE 20 are connected using a charging cable 50, and the charging cable 50 may be permanently installed in the charging station.

An environment of using the charging device may vary according to the charging mode of charging the EV 10 classified as described above. For example, mode 1 may not exceed 16A on the supply side, may not exceed 250V AC 1186 single-phase or 480V AC three-phase, and uses a power and a protective earth conductor. Mode 2 may not exceed 32A and 250V AC single-phase or 480V AC three-phase and uses a standardized single-phase or three-phase socket-outlet. Mode 3 is used to connect the EV through the EVSE permanently connected to an AC supply network. Mode 4 is used when a charging cable is permanently connected to a charging station.

Here, mode 2, mode 3 and mode 4 have conditions required for EVSE 20 or between the EVSE 20 and the EV 10.

First, it is detection of electrical continuity of the protective conductor (PE conductor). While the vehicle is charged in mode 2, mode 3 or mode 4, the electrical continuity of the PE conductor should be continuously monitored by the EVSE. When there is no electrical continuity of the PE conductor, the EVSE 20 should be switched off.

Next, it is verification that the vehicle is properly connected. The EVSE 20 may determine whether the connector is properly inserted in the inlet of the vehicle and whether the connector is properly connected to the EVSE 20.

Next, it is continuous checking of the protective earth continuity. Continuity of equipment earth between the EVSE 20 and the vehicle should be verified continuously.

Next, it is energization of power supply to the vehicle. If the pilot function between the EVSE 20 and the EV 10 is not correctly set in a single state of allowing supply of power, supply of power to the system will not be performed.

Next, it is deenergization of the power supply to the vehicle. When the pilot function is blocked or the single state of the pilot wire does not allow supply of power any more, although supply of power to the vehicle cable will be blocked, power will still remain in the control circuit.

Meanwhile, in mode 1, mode 2 and mode 3, digital communication is selectively allowed.

In mode 4, exchange of digital information may be accomplished so that the vehicle may control the off-board charger, except a dedicated off-board charger.

In addition, in mode 1, mode 2 and mode 3, the PE conductor may be used to establish a connection of an equal level between the earth terminal of the EVSE 20 and the exposed conductor of the vehicle.

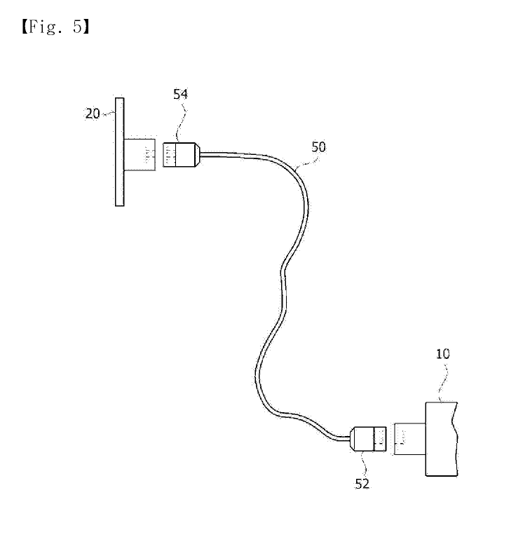

Next, an interface for establishing a connection between the EV and the EVSE is described. FIG. 5 is a view showing an example of a charging cable for establishing a connection between an EV and an EVSE. The connector 52 of the charging cable 50 is connected to the inlet of the vehicle, and the plug 54 of the charging cable 50 may be connected to the charger side, e.g., the socket-outlet.

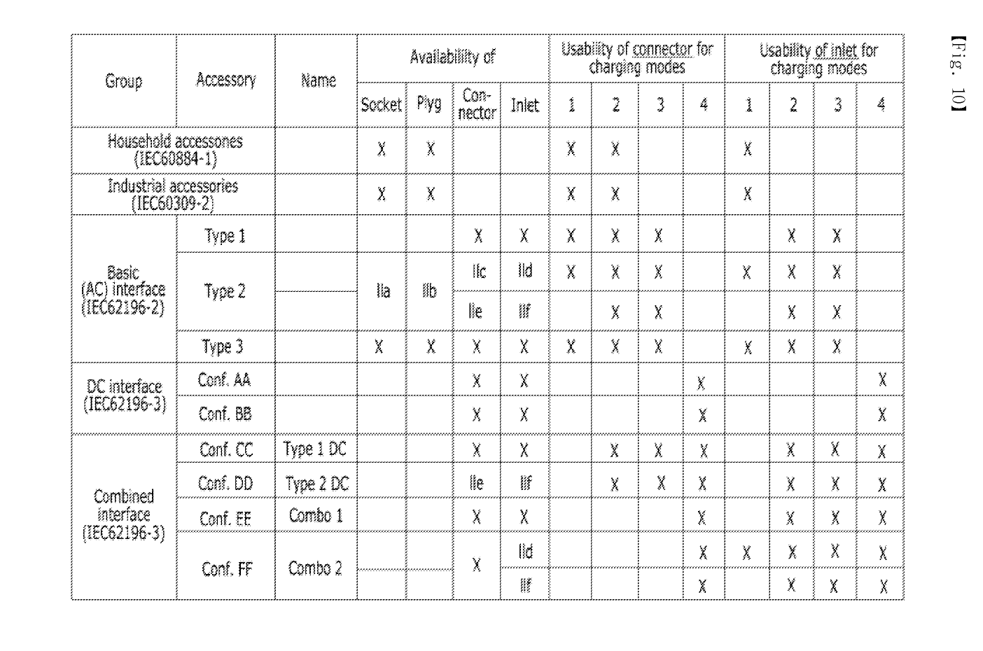

The interface type applicable according to the charging mode of charging the EV 10 is as shown in FIG. 10.

To connect the EV 10 and the EVSE 20, earth connection should be preceded first, and a pilot connection should be performed after a proximity and power connection is established. To release the connection of the EV 10 and the EVSE 20, the pilot connection should be released first of all, and the earth connection should be released finally.

The basic (AC) interface (IEC 62196-2) is classified into type 1, type 2 and type 3 and is applicable to the connector and the plug 54 of the charging cable 50 in each mode according to Table 1.

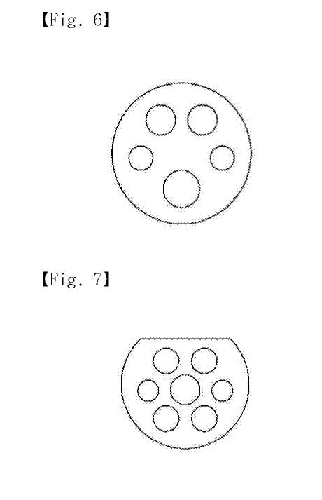

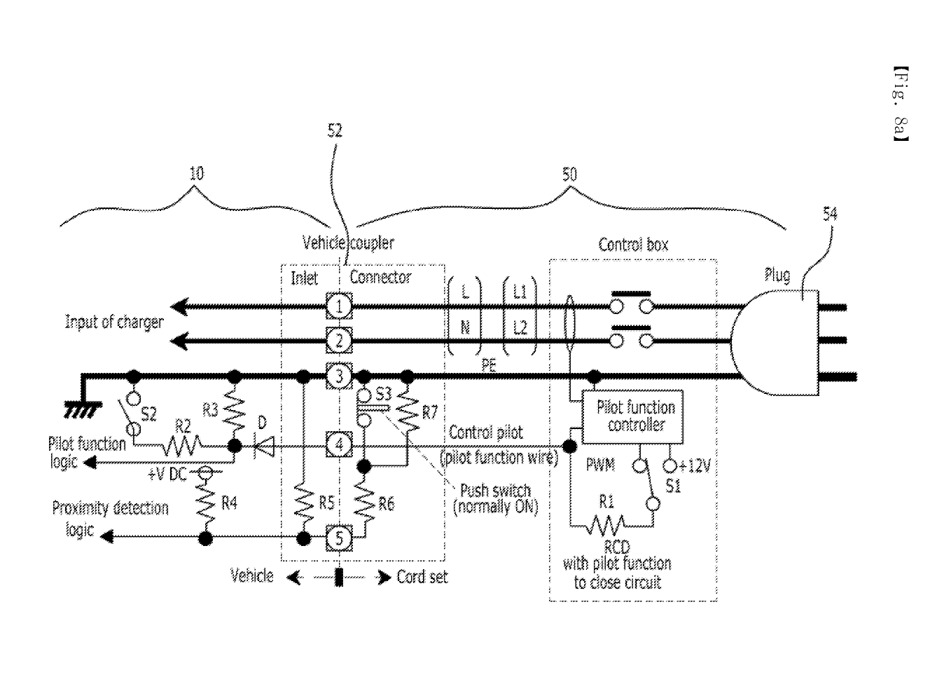

The basic interface may include, for example, seven contacts in maximum. FIG. 6 is a view showing an example of basic interface type 1 for single-phase, and FIG. 7 is a view showing an example of basic interface type 2 for three-phase. Here, the interface for three-phase may also be used to supply single-phase. However, this is only an example, and the shape of the interface, the number, the position and the size of contacts may be diversely modified.

A desirable current rate is 250V 32A for the interface of single-phase, and a desirable current rate is 480V 32A for the interface of three-phase. The inlet of a general vehicle may be designed to be interchangeable between a single-phase interface and a three-phase interface.

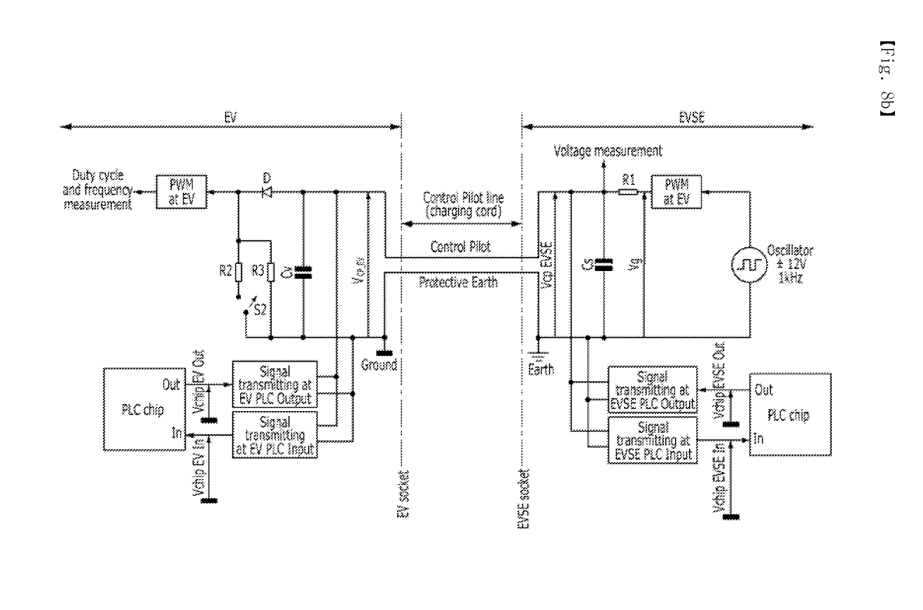

FIG. 8a is a view showing a connection relation between the EVSE and the EV. It shows an example of applying the basic interface of singe-phase to mode 2.

Referring to 8a, the plug 54 of the charging cable 50 is connected to the EVSE (not shown). In addition, the connector 52 of the charging cable 50 is connected to the inlet of the EV 10. At this point, the inlet of the EV 10 includes port No. 1, 2, 3, 4 and 5, and each of the ports is connected to contact No. 1, 2, 3, 4 and 5 of the connector 52.

The AC power supplied from the EVSE may be inputted through port No. 1 and 2. Port No. 3 may be a port connected to the protective earth (PE). A control pilot (CP) signal may be transferred through port No. 4. The CP signal may be a signal for requesting start or stop of power transfer or for controlling electrical energy. The CP signal is generated by a CP generator in the EVSE 20 or the charging cable 50 and may be transferred passing through a pilot function controller of the charging cable 50. The CP signal transferred through port No. 4 may be inputted into the pilot function logic in the charging device 100 of the EV 10. To this end, if the CP signal is inputted, the switch S2 in the charging device 100 of the EV 10 may be closed. In this specification, the CP signal may be interchangeably used together with the pilot function signal. In addition, port No. 5 is a proximity detection (PD) port. If the PD port contacts with the PD contact of the charging cable 50, the proximity detection logic may put into operation.

FIG. 8b is a view showing an example of a circuit diagram expressing the connection relation between the EV and the EVSE.

Referring to FIG. 8b, the earth of the EVSE is connected to the ground of the EV. Then, the EVSE generates and outputs a PWM signal having a predetermined duty cycle. The PWM signal generated by the EVSE may be inputted into the charging device 100 in the EV 10 through the control pilot (CP) line. To this end, when the PWM signal, i.e., the CP signal, is inputted, the switch S2 in the charging device 100 of the EV 10 may be closed. Here, Cs denotes a capacitor on the EVSE side, and Cv means a capacitor on the EV side.

Meanwhile, each of the EV and the EVSE may include a PLC chip and perform power line communication (PLC) through the PLC chip. To this end, the PLC chip included in each of the EV and the EVSE includes an input port (In) and an output port (Out), and each of the input port (In) and the output port (Out) may be connected to a line branched from a line through which the CP signal is transferred and a line branched from a line to which the earth is connected.

Meanwhile, the charging device 100 of the electric vehicle provides the power inputted through the inlet to the battery.

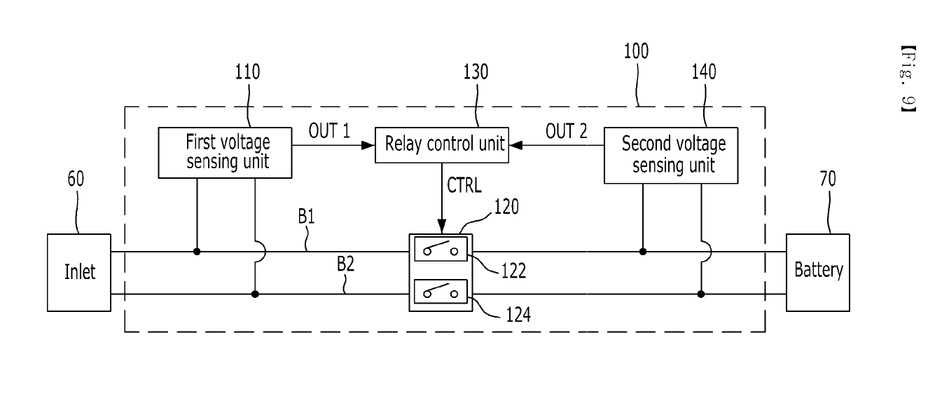

FIG. 9 is a block diagram showing a charging device 100 of an electric vehicle.

Referring to FIG. 9, the charging device 100 is connected to the inlet 60 and provides the battery 70 with the power supplied through the bus bars B1 and B2.

The charging device 100 may include a first voltage sensing unit 110, a relay unit 120, a relay control unit 130 and a second voltage sensing unit 140.

The first voltage sensing unit 110 is arranged between the inlet 60 and the relay unit 120 and senses the voltage outputted from the inlet 60. Plus (+) voltage is supplied to the first bus bar B1, and minus (−) voltage is supplied to the second bus bar B2. The first voltage sensing unit 110 may sense the plus voltage of the first bus bar B1 and the minus voltage of the second bus bar B2. That is, the first voltage sensing unit 110 may sense magnitudes of the plus voltage and the minus voltage outputted from the inlet 60. The first voltage sensing unit 110 outputs a sensing result as a first sensing signal (OUT1).

The second voltage sensing unit 140 is arranged between the relay unit 120 and the battery 70 and senses the voltage outputted from the battery 70. The second voltage sensing unit 140 may sense the plus voltage of the first bus bar B1 and the minus voltage of the second bus bar B2. That is, the second voltage sensing unit 140 may sense magnitudes of the plus voltage and the minus voltage outputted from the relay unit 120. The second voltage sensing unit 140 outputs a sensing result as a second sensing signal (OUT2).

The relay unit 120 may be switched on and off according to a control signal of the relay control unit 130 to control charge of the battery 70. The relay unit 120 includes a switching element and may be configured of a semiconductor circuit or a bimetal switch, which perform the same function. The relay may include a first relay 122 connected to the first bus bar B1 and a second relay 124 connected to the second bus bar B2.

The relay unit 120 connects the inlet 60 and the battery 70 and may send the energy supplied from an external power through the plug to the battery to charge the battery.

The relay control unit 130 controls on/off of the relay unit 120, receives sensing signals of the first voltage sensing unit 110 and the second voltage sensing unit 140, and outputs a relay control signal CTRL for controlling the relay unit 120 according to the sensing signals.

Describing specifically, the relay control unit 130 may receive the first sensing signal OUT1 and control to switch off the relay unit 120 when the inlet voltage is in a reverse phase. That is, when the plus voltage and the minus voltage of the inlet output voltage are changed to each other, the relay is switched off to protect the system.

In addition, the relay control unit 130 receives the first sensing signal OUT1 and the second sensing signal OUT2, determines whether the relay is in a welded state by comparing the two sensing signals, and controls on/off of the relay unit 120 according to the state.

In addition, when the relay is switched off after charging the electric vehicle is completed, the relay control unit 130 may improve the lifespan of the relay by comparing voltages before and after the relay unit 120 and switching off the relay.

When charging the electric vehicle is completed, the relay control unit 130 compares the first sensing signal OUT1 and the second sensing signal OUT2, and if the difference of voltage before and after the relay unit 120 exceeds a set reference value, it is determined that the relay is normally open, and thus the relay is switched off, and charging may be terminated. Contrarily, the relay control unit 130 compares the first sensing signal OUT1 and the second sensing signal OUT2, and if the difference of voltage before and after the relay unit 120 is smaller than the set reference value, it is determined that the relay is not switched off normally and welded, and thus the relay unit 120 may be switched off after switching on the relay unit 120.

For example, the relay unit 120 is switched off after charging the electric vehicle is completed, and it may be determined that the relay is normally switched off if the difference between the output voltage of the inlet 60 and the output voltage of the relay unit 120 is 20V or higher and determined that the relay unit 120 is welded if the difference between the output voltage of the inlet 60 and the output voltage of the relay unit 120 is smaller than 20V.

At this point, the state of the first relay 122 connected to the plus terminal of the first bus bar B1 and the state of the second relay 124 connected to the minus terminal of the second bus bar B2 may be determined separately.

The first relay 122 of the plus terminal is switched off after charging the electric vehicle is completed, and voltages on both sides of the first relay 122 are compared, and if the difference of voltage is 20V or higher, it may be determined that the first relay is normally switched off. In the same way, voltages on both sides of the second relay 124 are compared after the second relay 124 of the minus terminal is switched off, and it may be determined that the second relay 124 is welded if the difference of voltage is smaller than 20V. At this point, the relay control unit 130 outputs a control signal CTRL to switch off the relay unit 120 after switching on the relay unit 120. That is, when any one of the first relay 122 and the second relay 124 is in a welded state, the relay is switched on and switching off again so that the relay may operate normally.

Although the embodiments according to the present invention have been described above, these are only for illustrative purposes, and those skilled in the art may understand that diverse modifications and embodiments of the equal scope are possible from the embodiments. Accordingly, the true scope of the present invention should be defined by the claims described below.

1. A charging device of an electric vehicle, the device comprising:
an inlet connected to a connector of a charging cable to receive power from an electric vehicle supply equipment and receive a control pilot signal;
a relay unit arranged between the inlet and a battery so that output voltage of the inlet may be provided to the battery;
a first voltage sensing unit for sensing the output voltage of the inlet;
a second voltage sensing unit for sensing output voltage of the relay unit; and
a relay control unit for receiving output signals of the first voltage sensing unit and the second voltage sensing unit, determining whether the sensed voltages are voltages within a normal range, and controlling on and off of the relay unit.

2. The device according to claim 1, wherein the relay control unit controls the relay unit to be switched off when the output voltage of the inlet is in a reverse phase.

3. The device according to claim 1, wherein the relay control unit compares the output voltage of the inlet and the output voltage of the relay unit after charging the electric vehicle is completed, and determines that the relay is welded if a difference between the voltages is smaller than a set voltage difference.

4. The device according to claim 3, wherein the relay unit includes:
a first relay connected to a plus terminal of the inlet; and
a second relay connected to a minus terminal of the inlet, wherein
the relay control unit determines that a corresponding relay is welded if any one of a voltage difference between both sides of the first relay and a voltage difference between both sides of the second relay is smaller than a set voltage difference.

5. The device according to claim 4, wherein the relay control unit switches off the first relay and the second relay after switching on the relays when it is determined that any one of the first relay and the second relay is welded.

6. The device according to claim 1, wherein the inlet includes:
port No. 1 and port No. 2 connected to contact No. 1 and contact No. 2 of the connector of the charging cable to receive AC power;
port No. 3 connected to contact No. 3 and a protective earth of the connector of the charging cable;
port No. 4 connected to contact No. 4 of the connector of the charging cable to receive a control pilot signal; and
port No. 5 connected to contact No. 5, i.e., a proximity detection contact, of the connector of the charging cable.

7. The device according to claim 6, wherein the control pilot signal is a pulse width modulation (PWM) signal, and when the control pilot signal is inputted into port No. 3, power is inputted into port No. 1 and port No. 2.

8. A method of controlling on/off of a relay unit when an electric vehicle is charged, the method comprising:
sensing an output voltage of an inlet;
sensing an output voltage of a relay unit; and
controlling on/off of the relay unit by determining whether output voltages of the inlet and the relay unit are voltages in a normal range, wherein
the inlet is connected to a connector of a charging cable to receive power from an electric vehicle supply equipment and receive a control pilot signal, and
the relay unit is arranged between the inlet and a battery so that the output voltage of the inlet may be provided to the battery.

9. The method according to claim 8, wherein the step of controlling on/off of the relay unit controls the relay unit to be switched off when the output voltage of the inlet is in a reverse phase.

10. The method according to claim 8, wherein the step of sensing the output voltages of the inlet and the relay unit is performed after charging the electric vehicle is completed, and the step of controlling on/off of the relay unit compares the output voltage of the inlet and the output voltage of the relay unit and determines that the relay is welded if a difference between the voltages is smaller than a set voltage difference.
